(19) United States
(12) Patent Application Publication
(10) Pub. No.: US 2014/0061957 A1
(43) Pub. Date: Mar. 6, 2014

(54) SUBMERGED AERATOR

(71) Applicant: Higra Industrial LTDA, (US)

(72) Inventor: Silvino Geremia, Sao Leopoldo (BR)

(73) Assignee: HIGRA INDUSTRIAL LTDA, São Leopoldo (BR)

(21) Appl. No.: 13/776,926

(22) Filed: Feb. 26, 2013

(30) Foreign Application Priority Data
Feb. 27, 2012 (BR) 10 2012 004263-0

(51) Int. Cl. B01F 3/04

(52) U.S. Cl. CPC B01F 3/04099
USPC 261/24

(57) ABSTRACT

A submerged aerator is provided with a motor-pump assembly installed submerged, supported by a floating structure of a central articulation of a vertical supporting tube and rotating vertical shaft, where the aerator is provided with two propellers, also called rotors, which promote mixing and suction of atmospheric air for incorporation in the effluent, and a upper driving assembly, mounted outside the effluent and on the floatation structure, which enables the motor-pump assembly performing a partial rotating movement under the effluent due to the geometry of the crank rod system.

### TECHNICAL FIELD

This application of privilege relates to a submerged aerator for oxygenation and mixing of liquids applied in wastewater treatment or any other operations where there is need of mechanical incorporation of oxygen to the liquid. More specifically, the present privilege is aimed at a aeration system with submerged rotors for use in fluids aeration, with applications in sewage treatment systems where the aeration of the waste fluids is an important part of the treatment system, because it enters in the aerated fluid the oxygen required for the respiration of aerobic bacteria that make the digestion of the organic matter present in the fluid being treated. The application of the aerator can also be made in breeding sites of fishes, shrimp and other aquatic animals that require an aerated aquatic environment. In addition, the aerator proposed here can also be used to accelerate the fluids mixture, through the movement it causes in the fluids being aerated.

### BACKGROUND OF RELATED ART

The aeration of waste fluids must take into account several factors, as, for example, the need for an aeration that does not generate aerosols into the atmosphere and to promote a homogeneous mix of all effluents. The energy efficiency of the system is also important, and systems that make low power consumption aeration are important from an economic standpoint. The maintenance cost of the system is also an important factor and low maintenance cost robust aeration systems are desirable to minimize this maintenance cost. Technical solutions that translate into a reduction of implementation structures, as anchorage and support of the aerator, are widely desired.

Proposals prior to the aeration of liquids include pumps that pump air into the fluid to be aerated. Various devices have already been proposed for aeration systems. In PIO215705-5 an aerator consisting of porous plastic is shown. In PI0106956-0 is also shown an aerator which causes air to be driven through holes of the multiventuri double casing.

In turn, the conventional submersed aerators, as are also called the submerged pumps, oxygenate liquids through a pumping system where the liquid is pressurized through an axial flow impeller inside an ejector nozzle. The liquid is conducted through this ejector nozzle, producing a speed increase of the fluid due to the reduction of the passage section in certain point, followed by a sharp rise of this passage section, forming a low pressure zone, aspirating, consequently, the surface air and mixing it in the liquid. These submersed aerators are known by the technicians, being understood by the state of the art, and are described in various documents. Despite the ejectors nozzles of the several aerators are different, all work based on the principle described above.

Typically, conventional aerators and submerged mixers oxygenate liquids in a single direction and thus having an area of activity limited by the position of installation of the equipment, where the zone of action resembles a taper. It is in this zone where there is a higher concentration of oxygen. Consequently, at the surroundings of the submerged pump there will be low oxygen mixture embedding regions creating dead zones. In view of this unidirectionality, there was need of installing a larger number of equipment used in wastewater treatment and thus a well-planned installation lay-out in order to occur the largest area of activity possible.

Aiming to overcome this technical drawback, the PI0604125-6 teaches the construction of an aerator without ejector nozzle where there is a 360 degrees movement of the motor-rotor assembly around its rotating shaft. Now, the oxygenation index depends directly on the amount of time that the air bubbles formed in the mixture remain in contact with the liquid being treated and the greater area of activity possible.

The privilege described proposes submerged aerator for oxygenation and mixing of liquids without using the ejector nozzle, by creating a low pressure zone immediately ahead of the rotor aspirating the ambient air of the surface by the rotor hub. The low pressure zone is formed by the flow provided by the rotor to the liquid. The rotor is provided with air passages on its hub. These air passages are ducts which connect the low pressure zone with the ambient air through the suction casing and tubing. The rotor with its blades, in varying numbers, and an angle greater than zero formed by the plane of the output face of the rotor and the blade section, increases the effect of the low pressure zone in front of the air passages. The blades intend that the helical path printed to the liquid flow increases the effect of the centrifugal force. With that, it is created a low pressure zone in front of the air passages present in the rotor hub by drawing ambient air through the suction casing and the piping, mixing it with the treated liquid, causing the oxygenation thereof.

Although the breakthrough provided by the solution of the BR PI0604125-6, problems still remain. The rotation of the impeller imparts to the assembly a force against the rotor flux, requiring a robust structure capable of sustaining the forces generated. Likewise, there is a need for an anchoring system in the various directions of rotation of the rotor.

### SUMMARY

The objective of this invention is to create a submerged aerator electromechanical able to reach a large zone of aeration and mixing in the treatment, taking advantage and distributing the power from the electric motor to two opposite directions, with rotational movement and balance of forces to the maximum reduction of its floating structure. Structurally it is proposed an aerator equipped with double submerged rotor, where the rotors are opposed, mutually nullifying the forces generated by the thrust of each one individually.

### BRIEF DESCRIPTION OF THE DRAWINGS

The invention may be better described with the help of the figures which represent:

FIG. 1 shows a top view of the aerator with the axis of the motor-pump assembly (1) aligned;

FIG. 2 shows a top view of the aerator with the axis of the motor-pump assembly (1) in an intermediate position;

FIG. 3 shows a top view of the aerator with the axis of the motor-pump assembly (1) in angular position;

FIGS. 4 and 5 show a top view with the shaft of the assembly motor-pump (1) in positions of alignment (FIG. 4) and intermediate (FIG. 5) in the directions opposite to those of FIGS. 1, 2 and 3.

FIG. 6 shows a side view of the aerator with the motor-pump assembly (1) perpendicular to the view plane.

FIG. 7 represents the aerator in its side view with the motor-pump assembly (1) aligned with the plan view.

FIGS. 8 and 9 illustrate a perspective view of the aerator;

FIG. 10 shows the motor-pump assembly (1) in section.

FIG. 11 shows the crank connecting rod system (13) that exerts a rotational movement to the aerator through driving of a gear-motor (12).

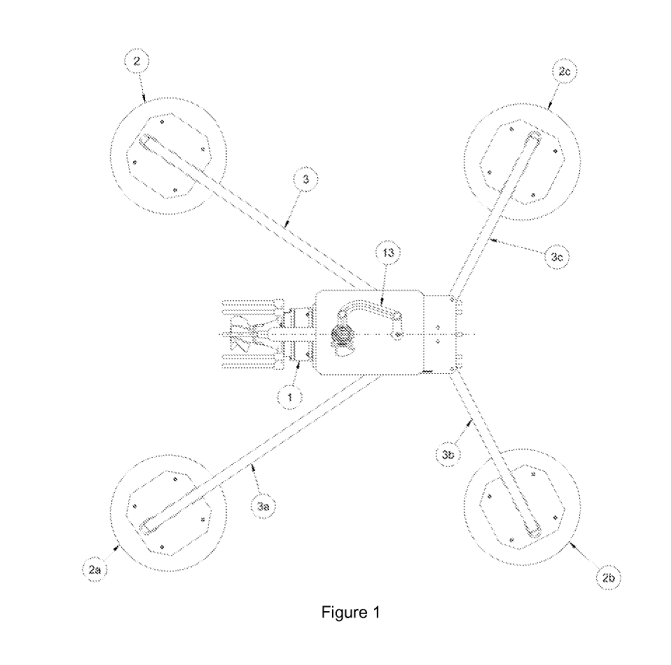

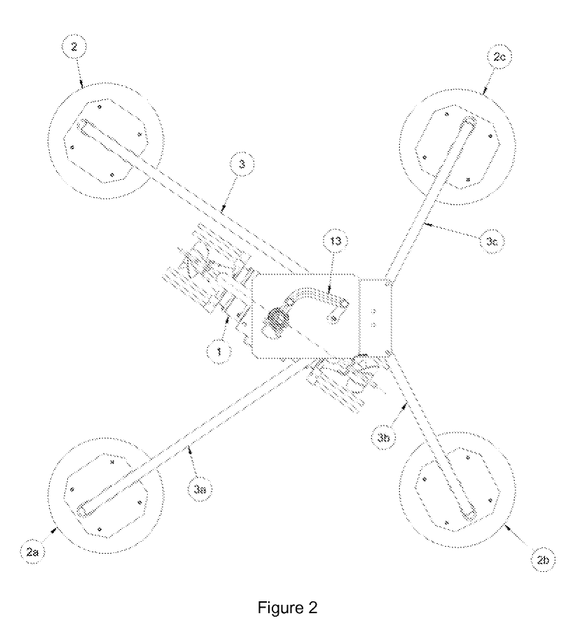

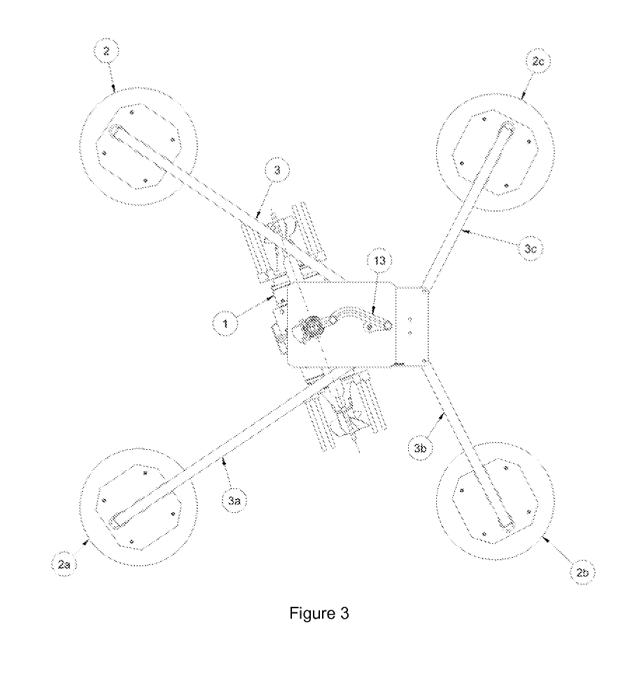

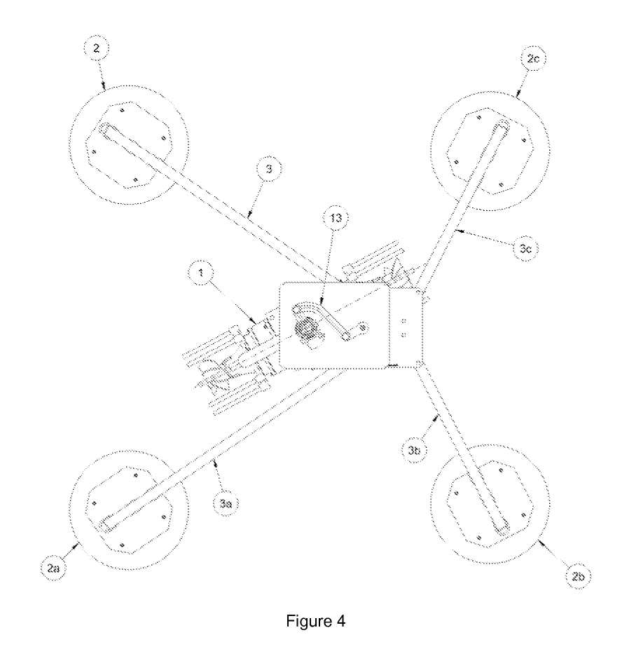

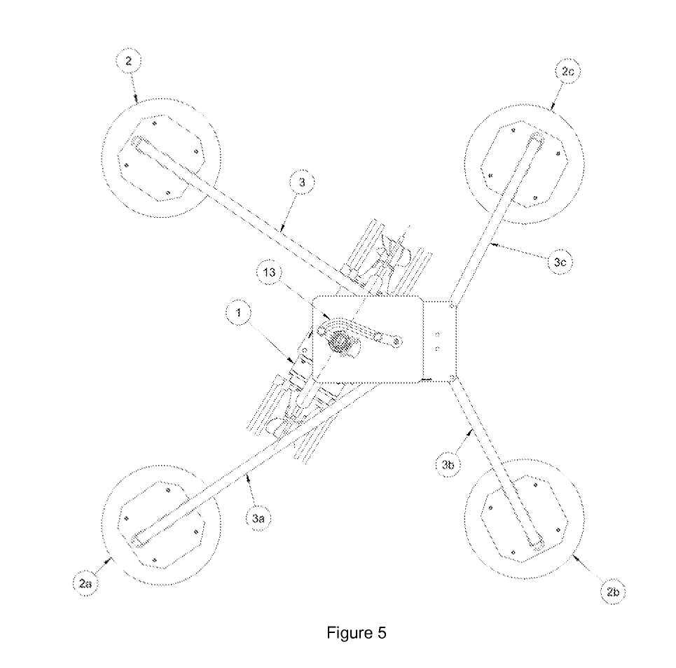

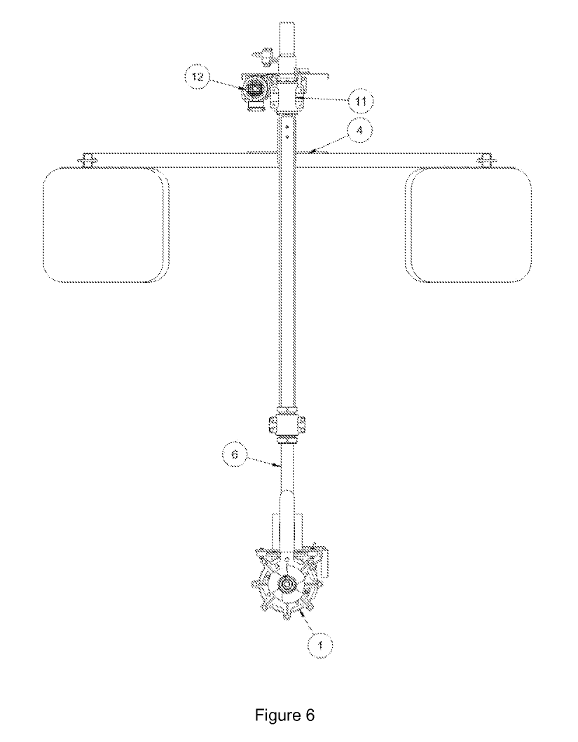

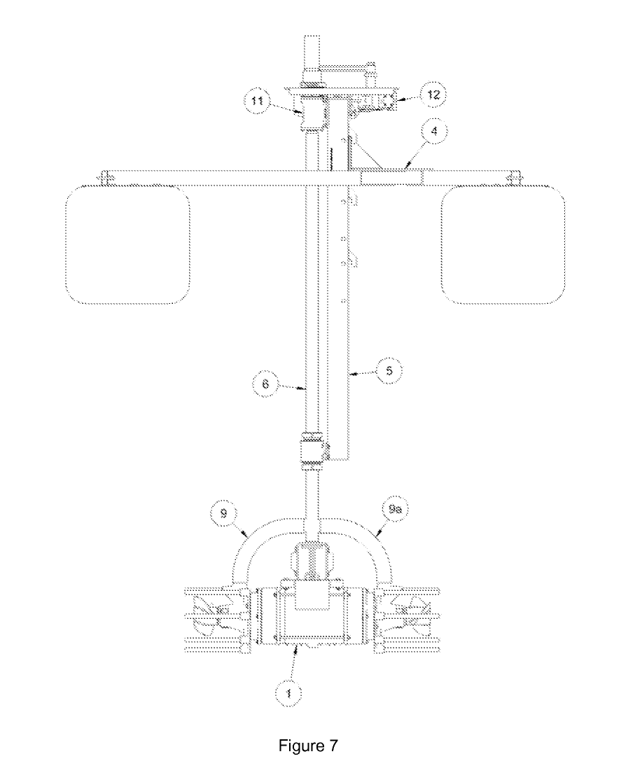

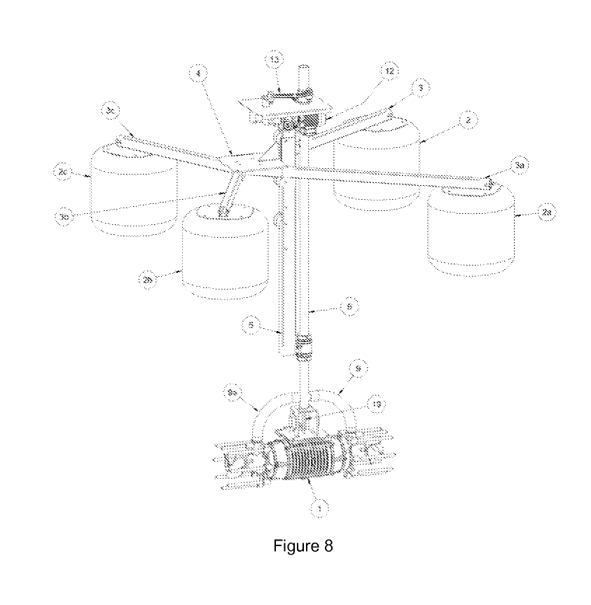

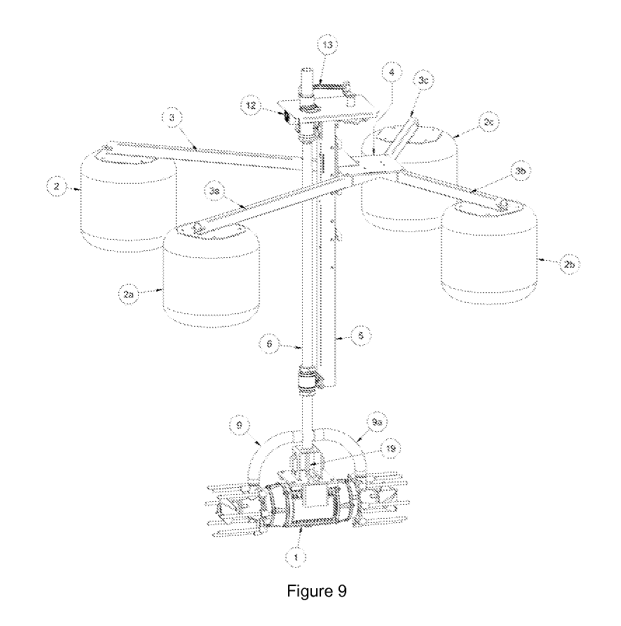

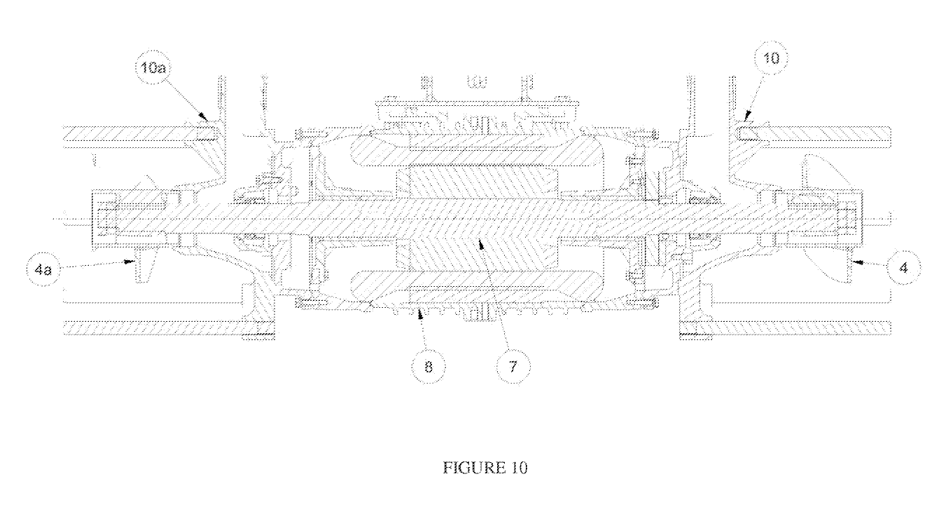

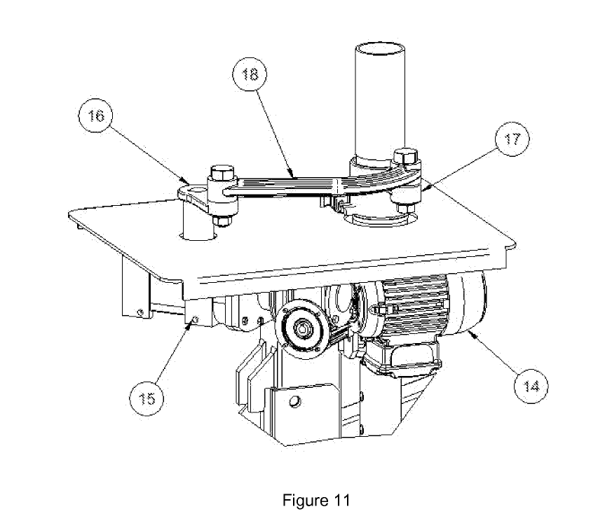

### DETAILED DESCRIPTION

The submerged aerator has a motor-pump assembly (1) installed submerged, supported by a floating structure, where at their ends floaters are fixed (2), usually in 4 units (2, 2a, 2b and 2c), which are joined by arms (3, 3a, 3b and 3c), of a central articulation (4), of a vertical support tube (5) and the rotary vertical shaft (6) maintaining the motor-pump assembly (1) balanced, leveled and submerged.

The pump-motor assembly (1) of the aerator is provided with two propellers (4), also called rotors, which promote mixing and suction of atmospheric air for incorporation into the effluent, as already known in the state of the art and reported in PI 0604125-6. These two propellers (4 and 4a) are arranged axially to the motor-pump assembly (1) on opposite ends and mounted on the same drive shaft (7), since there is only one electric motor (8) responsible for triggering the two propellers (4 and 4a).

Because they are driven by the same shaft (7) and electric motor (8) the propellers (4 and 4a) have their geometry inverse one to another, since the direction of rotation of the shaft (7) is unique. Thus, the propellers (4 and 4a) always promote the mixing of pumped fluid in the axial direction out of the machine, i.e. from the center of the electric motor (8) to its ends. Electric motors with the use of its two shaft ends such that used in this construction are known in the state of the art.

The motor-pump assembly (1) works in horizontal position and in adjustable depths by adjusting the condition of the tank or treatment pond. The adjustment takes place through the vertical support tube (5) when mounting on the central articulation (4), where the first has different vertically distributed fixing points.

The suction of atmospheric air is accomplished by rotating vertical shaft (6) which is located out of water and which connects with the two hoses (9 and 9a) mounted on the suction chambers (10 and 10a) existing previously the propellers (4 and 4a).

The rotating vertical shaft (6) is connected to an upper main bearing (11) which is driven by gear-motor (12) via a crank rod system (13), forming the upper driving assembly. The upper driving assembly is mounted outside the effluent in the floating structure, and allows the pump-motor assembly (1) performing a rotational movement below the effluent. Due to the geometry of the crank rod system (13) the rotational movement performs half rotation to one side and half rotation to the other, or a partial rotation.

The use of a gear motor (12) for driving the rotating system is by necessity of a slow movement, different and much smaller of the rotation of the electric motor (14) mounted to the gear unit (15). The gear-motor (12) is mounted directly on the crankshaft lower (16) that connects with the larger crank (17) through connecting rod (18). Due to the difference in diameters of the cranks (16 and 17), the connecting rod (18) promotes a rotational motion of half rotation for a side and half rotation for other in the larger crank (17), while the lower crank (16) has its rotation constant and always to the same side, promoted by gear-motor (12). The crank rod system and gear-motor, used to move the aerator as is used in this construction, are known in the state of the art.

The electrical cables (19) of the aerator pass inside the rotating vertical stem (6) until the upper end thereof, which emerge through an existing hole in the greater crank (17).

Since the rotational motion is half rotation to one side and half rotation to the other, the electrical cables accompany this movement and do not require a collector and brush type connection system already known of the state of the art.

Well understood that other forms could be adopted to achieve the same technical result than those means employed in this invention. Thus, this invention is not restricted to a structural form of particular technical means disclosed herein, the first target result may be the achieved by the equivalent technical means, without however escaping from the scope of the invention

1. A submerged aerator, comprising:
a motor-pump assembly; and
a double rotor counter-posed and aligned axially to a drive shaft of a motor.

2. The submerged aerator, according to claim 1, wherein the double rotor comprises propellors which possess its inverse geometry in relation to another.

3. The submerged aerator, according to claim 1, further comprising at least one vertical support tube having different fixing points distributed vertically.

4. The submerged aerator, according to claim 1, characterized by the partial rotation of the submerged aerator.

5. The submerged aerator, according to claim 1, further comprising a rotational driving assembly including:
a gear-motor mounted directly in a lower crank, which connects with a larger crank via a connecting rod, wherein the diameters of the cranks are different and promote a rotational movement of half rotation to one side and half rotation to another side in the larger crank, while the lower crank has a constant rotation and always to the same side, promoted by the gear-motor.

6. The submerged aerator, according to claim 1, further comprising power cables configured to pass through a rotating vertical shaft until an upper end thereof, and emerge through an existing hole in the larger crank.
